(19) United States
(12) Patent Application Publication
(10) Pub. No.: US 2014/0232857 A1
(43) Pub. Date: Aug. 21, 2014

(54) THREE-DIMENSIONAL SURFACE INSPECTION SYSTEM USING TWO-DIMENSIONAL IMAGES AND METHOD

(71) Applicant: SIEMENS AKTIENGESELLSCHAFT, Munchen (DE)

(72) Inventors: Ronny JAHNKE, Falkensee (DE); Tristan SCZEPUREK, Berlin (DE)

(73) Assignee: SIEMENS AKTIENGESELLSCHAFT, Munchen (DE)

(21) Appl. No.: 14/267,429

(22) Filed: May 1, 2014

Related U.S. Application Data
(63) Continuation-in-part of application No. PCT/EP2012/068046, filed on Sep. 14, 2012.

(30) Foreign Application Priority Data
Nov. 2, 2011 (EP) 11187504.3

(51) Int. Cl. G01N 21/95; G01B 11/245

(52) U.S. Cl. CPC G01N 21/95; G01B 11/245
USPC 348/135

(57) ABSTRACT

The three-dimensional real structure of a component can be captured by means of best fit by simply recording two-dimensional images and comparing a known three-dimensional model. A component is placed on a measurement stage having reference marks and is photographed several times in two-dimensions. The photo recordings are compared with a three-dimensional model of the component. A three-dimensional model is produced using best fit of the two-dimensional recordings and the stored model.

### CROSS-REFERENCE TO RELATED APPLICATIONS

The present application is a 35 U.S.C. §111 Continuation in Part of International Application PCT/EP2012/068046, filed Sep. 14, 2012, which claims priority of European Patent Application No. 11187504.3, filed Nov. 2, 2011, the contents of which are incorporated by reference herein. The PCT International Application was published in the German language.

### FIELD OF THE INVENTION

The invention relates to a three-dimensional surface inspection system using two-dimensional recordings.

### TECHNICAL BACKGROUND

For many components, 100% optical examination of the entire three-dimensional component surfaces is necessary. This comprises, for example in turbine blades, the orientation of the cooling-air holes and the entire coating.

Optical examination and three-dimensional capture of a component involves known processes and apparatus. But, three-dimensional capture by two-dimensional photography is not rapidly and easily accomplished by known three-dimensional capture processes and apparatus. Furthermore, when an objective of the three-dimensional capture is to enable a component to be marked with markings relevant to further handling or treatment of the component, known systems and methods are time consuming and costly.

Known three-dimensional capturing systems are very time-consuming to use and costly.

### SUMMARY OF THE INVENTION

It is therefore the object of the present invention to solve the foregoing problems. A further object is to simplify the procedure of three-dimensional capture.

The objects are achieved by a three-dimensional surface inspection system and a method according to the invention.

A three-dimensional surface inspection system has a measurement stage on which a component may be placed for three-dimensional capture. At least one and particularly a plurality of cameras takes typically more than one two-dimensional recording of the component on the stage. The captured two-dimensional recordings are compared in a computer to a stored three-dimensional model. Then a three-dimensional model of the component is produced using a best fit of the two-dimensional photographed recordings and the stored three-dimensional model.

A plurality of reference marks are provided, which are typically used during the photographic stage as reference mark for the component being photographed. The reference marks are particularly on the measurement stage.

At least one of the reference marks preferably includes a plurality of markings arranged in a particular pattern. The reference marks may be arranged on a front end of the measurement stage or at least on corners of the stage.

There is illumination for surface inspection and the illumination unit may make selective illumination of the component. Extraneous light is suppressed.

The invention also concerns a method for three-dimensional capturing of a component. The method preferably uses an embodiment of the system described above. The component is placed in at least two different positions on the measurement stage to be two-dimensionally captured by the cameras. Then the three-dimensionality of the component is determined using a best fit with a known three-dimensional model of the component. The reference marks are used for ascertaining the orientation of the component on the stage, including after the orientation of the component has been changed. The component is captured by the individual two-dimensional images and the orientation of the component is captured with the assistance of the reference marks. The component is then finally adjusted to the known three-dimensional model using a best-fit analysis. Then individual images are mapped onto the three-dimensional model. This would enable for example the individual two-dimensional recordings to be combined with the known three-dimensional stored model to produce a three-dimensional contour of the component that was photographed.

The advantages of the invention are simple handling of the system and more accurate measurements.

In the figures:

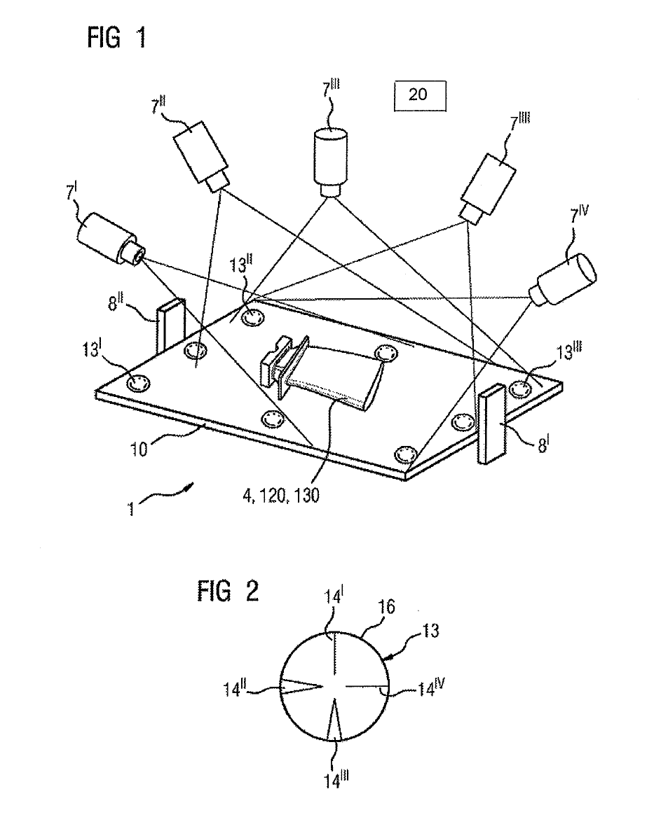

FIGS. 1-6 show exemplary embodiments of the invention.

FIG. 7 shows a turbine blade.

### DESCRIPTION OF EMBODIMENTS

The description and the figures illustrate merely exemplary embodiments of the invention.

FIG. 1 illustrates a three-dimensional surface inspection system 1 according to the invention. The three-dimensional surface inspection system 1 has a measurement stage 10, on which the component 4, 120, 130 to be inspected is located.

Around the component 4, 120, 130, at least one camera 7′ is present, the position of which is changed. Alternatively, a plurality of cameras 7′, . . . , 7^{V}, . . . , which are preferably fixedly mounted, are used.

The cameras 7′, 7″ are arranged such that they capture the entire surface of the component 4, 120, 130 which faces away from the measurement stage 10.

The mounting of the cameras 7′, 7″, . . . can be varied, depending on the types of components. For turbine blades 120, 130 of varying size and type (moving blade 120 or guide vane 130), the same fixed mounting of cameras 7′, 7″, . . . can be used.

At least one reference mark 13′, 13″, . . . (as illustrated in FIGS. 2 to 6) is present on the measurement stage 10 according to FIG. 1. In this case, there are preferably eight reference marks.

The three-dimensional surface inspection takes place as follows:
1. Providing an arrangement of the measurement stage 10, camera system (one or more cameras 7′, 7″, . . . ), and illumination device 8′, 8″;
2. Providing reference marks 13 on the measurement stage 10, or the measurement stage 10 already has them;
3. Positioning the component 4, 120, 130 on the measurement stage 10. It is preferred to position the component in a flat manner if the component is of elongate construction;
4. Recording individual images using all fixedly mounted cameras 7′, 7″, . . . or one camera 7′ in various positions;
5. Capturing the orientation of the component 4, 120, 130 from the individual images;
6. Finely adjusting the component to the known three-dimensional model using best fit analysis;
7. Mapping the individual images onto the associated three-dimensional model;
8. Optimizing the overlapping image regions by averaging, contrast setting or edge sharpness;
9. Turning components 4, 120, 130 and repeating from step 3;
10. Combining individual recordings two-dimensional with known stored three-dimensional model to produce “three-dimensional contour of the component.”

After the images have been recorded by the camera 7, as stated in Step 4 above, the succeeding steps in this inspection are performed preferably by a computer 20 which is a normal workplace computer, a micro controller, a special image processing unit or the like. One skilled in the art would understand how to program and operate the computer to achieve the operational functions 5-8 and 10 described above.

The surfaces of the components 4, 120, 130 are captured optionally using a projected light structure, in particular stripes, such that edges of the component 4, 120, 130 are captured better.

Optionally, the component 4, 120, 130 is selectively illuminated, in particular using projection devices, such that strongly reflective regions are not illuminated or illuminated less. This is for turbine blades 120, 130, for example the blade root 183, 400 (FIG. 7).

Extraneous light is preferably suppressed by monochromatic illumination and image evaluation.

A ring light on the camera objective is preferably used and/or lateral dark-field illumination is used to highlight small defects such as scratches, unevennesses, pressure points.

The reference mark 13, 13′ is preferably of annular design and/or arranged in the shape of a ring and has markings 14′-14^{IV}. The markings 14′, . . . 14^{IV} can be line-shaped or point-shaped (FIGS. 3, 4, 5, 6).

FIGS. 2-6 illustrate different reference marks which can be arranged or introduced on the measurement stage 10.

FIG. 2 shows a reference mark 13 having two line-shaped markings 14′, 14″, which extend radially from a circle line 16, and two V-shaped markings 14″, 14″′, the tips of which likewise extend radially. The sequence of the different markings 14′, . . . , 14^{IV} of a reference mark 13 is unimportant (likewise in FIG. 5).

FIG. 3 shows a circular structure of a reference element 13, which is formed by at least two, in this case four curved line-shaped markings 14′, . . . 14^{IV}, which in this case preferably form a circular structure.

The outer closed, circular line 16 can be present, or simply is an imaginary line representing the profile of the arrangements of the markings 14′, 14″, . . . (FIGS. 2-5).

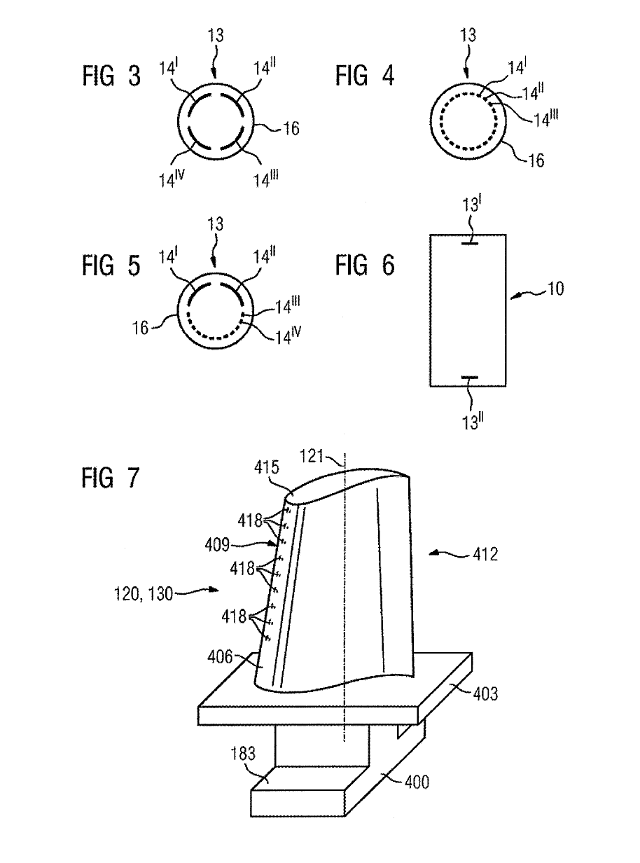

One alternative to the line-shaped markings 14′, 14″ according to FIG. 3 is a plurality of point-shaped markings 14′, 14″, . . . , according to FIG. 4 a reference element 13, 13′, 13″, which likewise form a circle or oval shape.

Likewise conceivable is a combination of line-shaped and circle-shaped (points) markings 14′, 14″, . . . , which preferably enclose a circle-shaped or oval-shaped structure, as is shown in FIG. 5.

The markings 14′, 14″, . . . can also be arranged in a square or rectangular shape.

FIG. 6 shows a measurement stage 10, on which preferably two reference marks 13′, 13″ are arranged.

The reference marks 13, 13′ are in this case line-shaped elements, which are preferably arranged on the front ends of the measurement stage 10.

At least two or preferably four reference marks 13, 13′, 13″, 13′″ according to FIG. 2, 3, 4, 5 or 6 can likewise be arranged in the corners of a measurement stage 10 (not illustrated).

Optionally, an identification (binary code) of the reference marks can take place, which is detectable using the camera 7′, 7″.

It is also possible optionally for the reference marks to be projected onto a desired stage using a projection device and to be measured subsequently (measuring tape). This option should preferably be used in a mobile system without coded examination stage.

The reference marks 13 serve to ascertain the orientation of the component 4, 120, 130, if the orientation thereof has been changed, in particular rotated (step 9). The recording of the component 4, 120, 130 from both sides can thus be stitched together. No reference marks on the component 4, 120, 130 are necessary.

The advantages are:
no three-dimensional measurement of the component 4, 120, 130 is necessary;
complete capturing of the surface, since no obstruction by clamping apparatus;
free positioning of the cameras is possible (alignments using reference marks);
no time-consuming three-dimensional measurement is necessary;
no obstruction through reference marks on the object under examination. Exact orientation illustration of all noticeable points of the examination object surface in three-dimensional;
subsequent measurement on the three-dimensional model is possible;
small data amounts (<10 MB) with respect to typical three-dimensional recordings (>100 MB);
quick illustration of the two-dimensional individual images on three-dimensional model.

FIG. 7 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a main blade 406 and a blade tip 415.

As a guide vane 130, the vane 130 may have a further platform (not shown) at its blade tip 415.

A blade root 183 which is used to fasten the rotor blades 120, 130 on a shaft or a disk (not shown) is formed in the fastening zone 400.

The blade root 183 is configured, for example, as a hammerhead. Other configurations as a fir tree or dovetail root are possible.

The blade 120, 130 comprises a leading edge 409 and a trailing edge 412 for a medium which flows past the main blade 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A, WO 99/67435 or WO 00/44949.

The blade 120, 130 may in this case be manufactured by a casting method, also by means of directional solidification, by a forging method, by a machining method or combinations thereof.

Workpieces with a single-crystal structure or single-crystal structures are used as components for machines which are exposed to heavy mechanical, thermal and/or chemical loads during operation.

Such single-crystal workpieces are manufactured, for example, by directional solidification from the melt. These are casting methods in which the liquid metal alloy is solidified to form a single-crystal structure, i.e. to form the single-crystal workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a single-crystal structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or single-crystal component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. Nos. 6,024,792 and EP 0 892 090 A1.

The blades 120, 130 may also have coatings against corrosion or oxidation, for example MCrAlX (M is at least one element from the group iron (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an interlayer or as the outermost layer).

The layer composition preferably comprises Co—30Ni—28Cr—8Al—0.6Y—0.7Si or Co—28Ni—24Cr—10Al—0.6Y. Besides these cobalt-based protective coatings, it is also preferable to use nickel-based protective layers such as Ni—10Cr—12Al—0.6Y—3Re or Ni—12Co—21Cr—11Al—0.4Y—2Re or Ni—25Co—17Cr—10Al—0.4Y—1.5Re.

On the MCrAlX, there may furthermore be a thermal barrier layer, which is preferably the outermost layer and consists for example of ZrO₂, Y₂O₃—ZrO₂, i.e. it is not stabilized or is partially or fully stabilized by yttrium oxide and/or calcium oxide and/or magnesium oxide.

The thermal barrier layer covers the entire MCrAlX layer. Rod-shaped grains are produced in the thermal barrier layer by suitable coating methods, for example electon beam physical vapor deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance. The thermal barrier layer is thus preferably more porous than the MCrAlX layer.

Refurbishment means that components 120, 130 may need to be stripped of protective layers (for example by sandblasting) after their use. The corrosion and/or oxidation layers or products are then removed. Optionally, cracks in the component 120, 130 are also repaired. The component 120, 130 is then recoated and the component 120, 130 is used again.

The blade 120, 130 may be designed to be hollow or solid. If the blade 120, 130 is intended to be cooled, it will be hollow and optionally also comprise film cooling holes 418 (indicated by dashes).

What is claimed is:

1. A three-dimensional surface inspection system, comprising:
a measurement stage on which a component is placed for three-dimensional capturing; and the system has at least one reference mark for reference to the component and a position of the component at the measurement stage;
a camera system at various selected locations, the camera system comprising a respective camera at least at some of the locations and/or a camera positionable at least at some of the locations, and the cameras and/or camera of the camera system are configured and oriented to take two-dimensional recordings of the component; and
a computer with a memory programmed with a three-dimensional model of the component, the computer memory is further programmed and operable to receive the two-dimensional recordings and to compare the two-dimensional recordings of the component by the camera system to the stored three-dimensional model, and to produce a three-dimensional model of the component to be measured using best fit of the two-dimensional recordings and the stored three-dimensional model.

2. The system as claimed in claim 1, further comprising an illumination unit configured for illuminating the component for surface inspection.

3. The system as claimed in claim 2, wherein the illumination unit comprises a projected light structure in the form of a stripe structure.

4. The system as claimed in claim 2, wherein the illumination unit comprises a projected light structure in the form of a stripe structure, which is configured to cause selective illumination of the component.

5. The system as claimed in claim 1, which is configured for extraneous-light suppression.

6. The system as claimed in claim 1, wherein the light suppression is by monochromate illumination and image evaluation.

7. The system as claimed in claim 1, further comprising the at least one reference mark has a plurality of markings on the at least one reference mark.

8. The system as claimed in claim 6, further comprising the markings are arranged in at least one of a curved shape, a circle shape and an oval shape.

9. The system as claimed in claim 1, further comprising the at least one reference mark has on itself at least one of identical markings, markings of different geometries, lines and points.

10. The system as claimed in claim 1, further comprising the measurement stage has the at least one of the reference marks thereon.

11. The system as claimed in claim 1, further comprising the at least one reference mark is arranged on at least one end of the measurement stage.

12. The system as claimed in claim 1, further comprising the reference marks are arranged at least at two of the corners of the measurement stage.

13. The system as claimed in claim 1, further comprising a camera objective of the at least one camera or of each camera has a ring light.

14. The system as claimed in claim 1, further comprising an illumination unit configured for causing lateral dark-field illumination.

15. The system as claimed in claim 1, wherein the at least one camera is mounted fixedly.

16. A method for determining three-dimensionality of a component, using a system as claimed in claim 1, the method comprising:
placing the component in various positions on the measurement stage;
two-dimensionally capturing a plurality of two-dimensional images of the component from different directions of view by the at least one camera; and
determining real three-dimensionality of the component using a best fit with a known three-dimensional model of the component.

17. The method as claimed in claim 15, further comprising, changing the orientation of the component during the capturing of the two-dimensional images.

18. The method as claimed in claim 15, further comprising:
determining the orientation of the component on the measurement stage after the orientation has been changed or the component has been turned, by reference to the at least one reference mark.

19. The method as claimed in claim 15, further comprising:
providing an arrangement of the measurement stage, the camera system and the at least one camera thereof and an illumination device for the component on the stage;
providing at least one reference mark on the measurement stage;
positioning the component on the measurement stage;
recording individual two-dimensional images of the component using at least one fixedly mounted camera of the camera system in various positions with respect to the arrangement;
capturing an orientation of the component captured from the individual images;
adjusting the component finely to a known three-dimensional model using best fit analysis;
mapping the individual two-dimensional images onto the associated known three-dimensional model; and
combining individual recordings of the component with the known stored three-dimensional model to produce a three-dimensional contour of the component.

20. The method as claimed in claim 1, further comprising:
after the mapping of the individual images onto the three-dimensional model, optimizing the overlapping image regions by averaging, contrast setting or edge sharpness.

21. The method as claimed in claim 1, further comprising after positioning the component and recording two-dimensional images of the component, repositioning the component on the measurement stage and again recording two-dimensional images of the component.
